(19) United States
(12) Patent Application Publication
(10) Pub. No.: US 2012/0178041 A1
(43) Pub. Date: Jul. 12, 2012

(54) Windowed Muzzle to Facilitate Oral Inspection

(76) Inventor: Thomas Paul Cogley, Pinellas Park, FL (US)

(21) Appl. No.: 12/987,098

(22) Filed: Jan. 8, 2011

(51) Int. Cl. A61D 5/00

(52) U.S. Cl. 433/1

(57) ABSTRACT

The device allows for an opening to be procured on either or both sides at one time on a muzzle that is at the same time being used to hold the mouth of the animal closed. The opening will allow the health professional such as a veterinarian to observe the oral cavity of the animal while being protected from the dogs biting teeth, the oral cavity which is an important aspect of the health of the animal can be assessed. The utility will allow for the shutting and opening of the sides through flaps by the use of Velcro®, snaps, twist tops, zippers, buttons, and mechanical movement such as one tube over another.

### BACKGROUND OF THE INVENTION

This invention is particularly suitable for veterinary medicine and the allied health sciences. In these fields some of the animals that are worked on may be dangerous and bite the caregiver. Often the health of the animal needs to be assessed and assessment requires access to the mouth. The oral cavity is a very good indicator of an animal's health. Many diseases directly involving the oral cavity or the internal organs can be accessed through examination of the mouth and teeth. Access to the mouth is important in emergency situations to evaluate shock and circulatory parameters as well as hepatic injury or renal disturbances. However, until now the need for protection would mean that access to the mouth would be denied. Caregivers have had to trade-off access to the oral cavity in order to gain protection from dangerous or frightened animals. A muzzle was needed that would provide a window that would give the health provider a means to visualize the oral cavity and gather the important information it can provide. The inventor, himself was prevented in many situations from being allowed access to the mouth during animal examinations and after years of frustration decided to take the time to design a muzzle to help remedy the situation and this obvious handicap.

### SUMMARY OF THE INVENTION

The Invention utilizes a muzzle made of various substances from leather to man-made synthetic fabrics. The fabric material, no matter what its form, will allow to it to conform over the animal's face and to have strength enough to keep the animal's jaw from opening and biting or harming the caregiver. This invention has taken into account the protection factor that muzzles have provided but in addition has added the ability to examine the mouth through a window in the muzzle. The muzzle is therefore more complicated than others heretofore developed and patented because it includes additional substance such as a window flap or sliding portion of a muzzle. For example the additional substance and nature of the invention includes the presence of a window on parts of the muzzle that when placed over each other allows the oral cavity to come into view. This window requires removal of some of the fabric normally found on other muzzles. With the addition of a strengthening strip of fabric centrally located in the window, security of the muzzle will continue. Security is also retained because the window or windows not being used are closed down by various hardware and/or ties placed on the sides or above said window. The invention also includes a form that utilizes a flap on both sides of the muzzle that remains static but is covered by the flap by means of hardware not normally found on muzzles. The substance of the hardware includes Velcro®, turn buttons, grommets, zippers, sockets, studs, washers, rivets and laces and any other binding type of hardware not specifically mentioned. Its form in part has been described by several patents (see references above). This muzzle exceeds all previously patented muzzles in its ability to afford protection from the biting or crushing teeth while at the same time optimizing the ability of a caregiver to examine the oral cavity.

### BRIEF DESCRIPTION OF THE DRAWINGS

FIG. 1 is the muzzle with side flaps that can be buttoned or unbuttoned to hide and make visible the animal's side teeth.

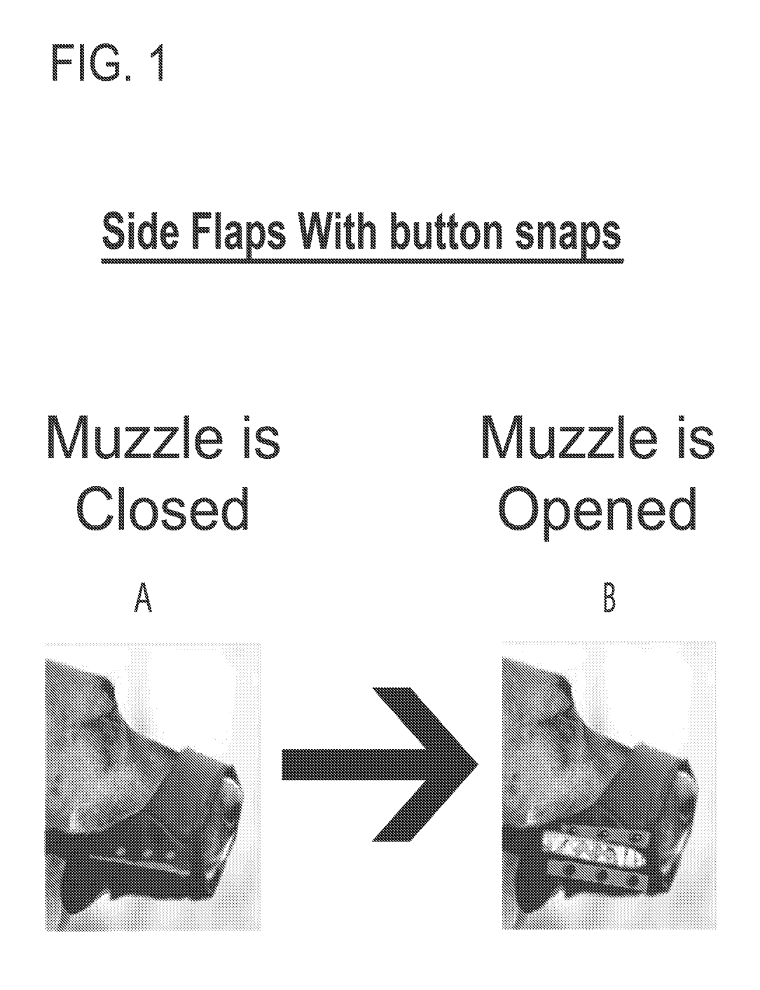

FIG. 2 is the muzzle with side flaps that contain Velcro® to show or hide the animal's side teeth when not using Velcro® or when using Velcro®.

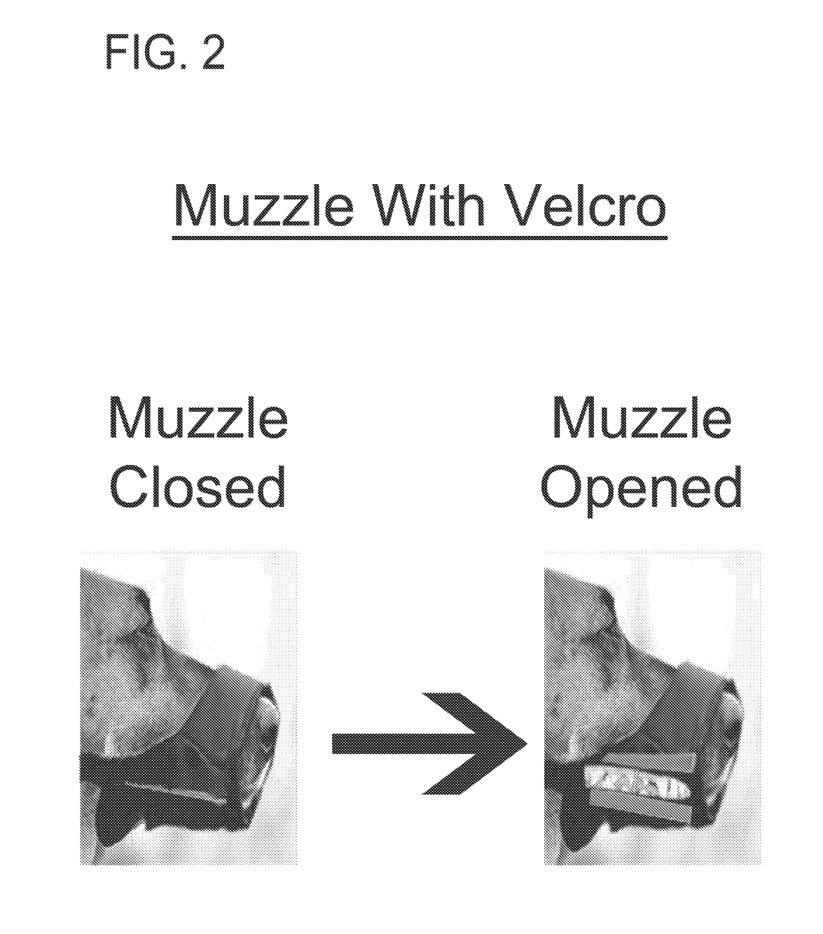

FIG. 3 is the muzzle with side slits that have brass buttons on them and are connected with straps. When strapped the side teeth are not visible, however when unstrapped the animals side teeth are visible.

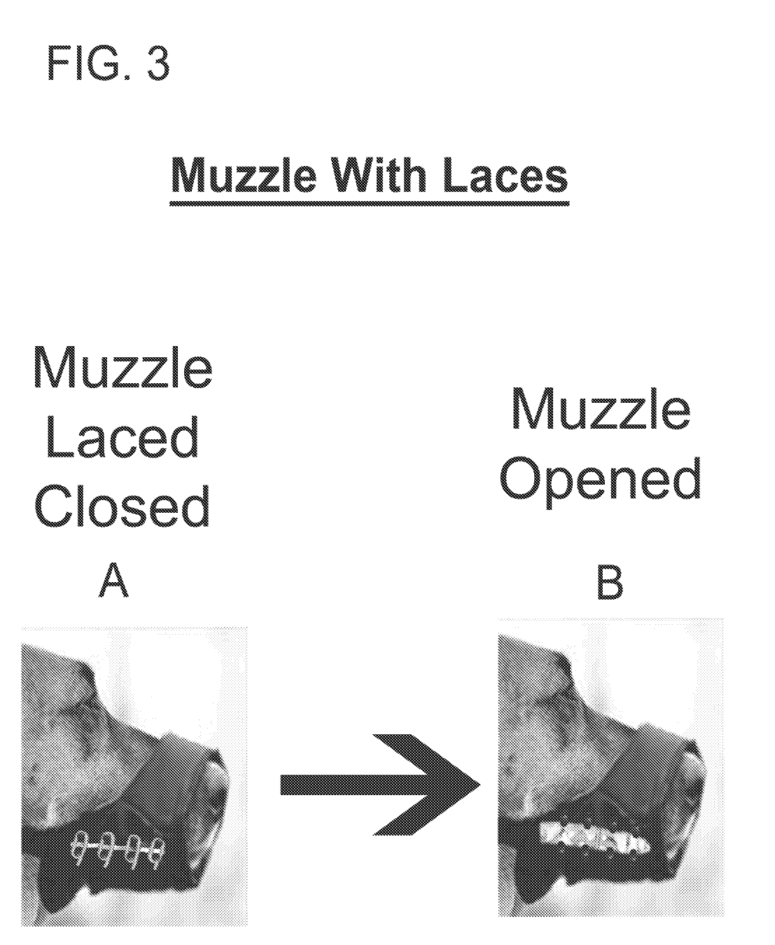

FIG. 4 is the muzzle with zippers on both sides. When zipped closed the animals side teeth are not visible, however when unzipped the side teeth are clearly visible.

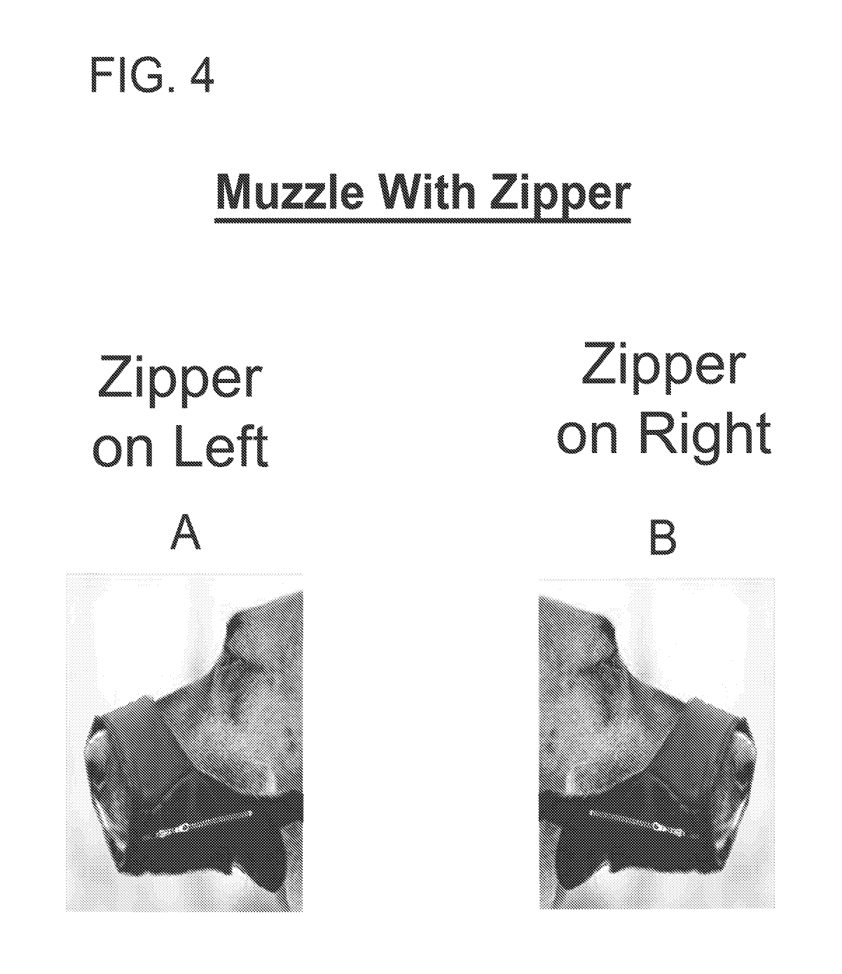

FIG. 5 is the muzzle with twist top buttons on both sides. When the side flaps are shut via the twist top buttons, the animals side teeth are not visible, however when twisted open and the side flaps are opened the animals side teeth are now visible.

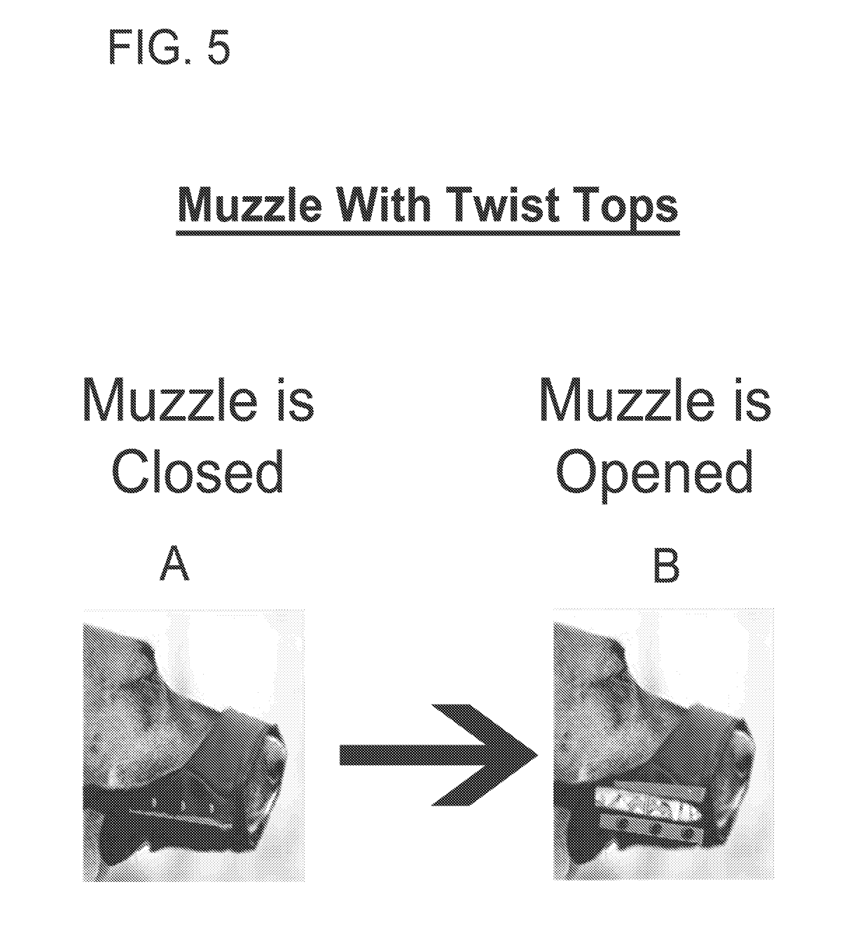

FIG. 6 is the muzzle completely created with the ability to twist it counterclockwise or clockwise. When turned counterclockwise both sides of the animals teeth are clearly visible through the muzzle, however when turned clockwise the side teeth are now hidden.

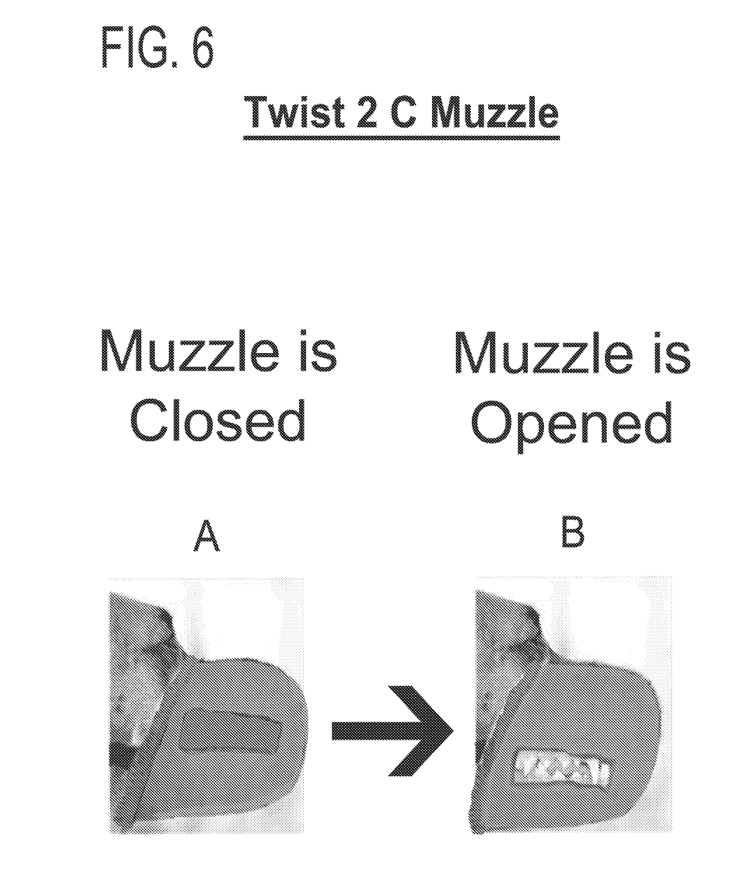

FIG. 7 is the mechanical blueprints as to how the twist muzzle in FIG. 6 works and is put together.

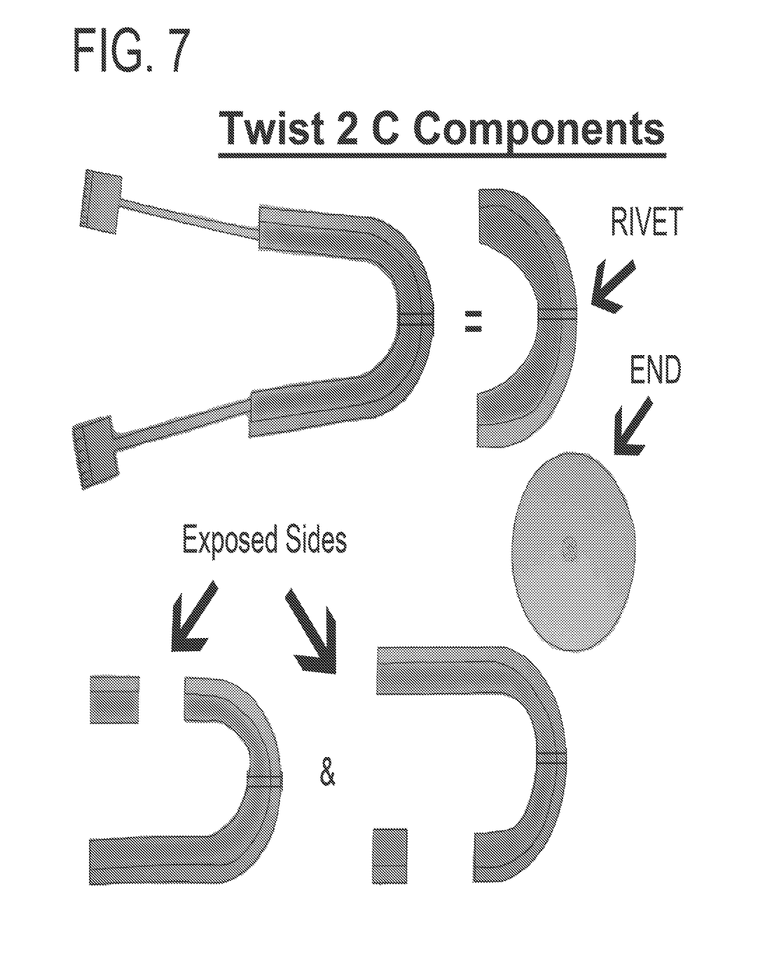

What the invention claimed is:

1. An animal muzzle designed with an easily accessible way to see the animal's molars; premolars and canine tooth along the entire side of its face. The view of the teeth is allowed without removing the muzzle. A portion of the muzzle is opened by lifting flaps. The muzzle retains its ability to keep the jaws shut and thereby preventing the animal from biting. There will be a thin piece of nylon attached in the center of both sides of the muzzle when the flaps are opened. This prevents the animal from nipping the owner or doctor of the animal. There will be side flaps on each side of the muzzle made of nylon, the flaps will be held down with button snaps.

2. A similar muzzle as in claim 1 however the side flaps will be held down by Velcro®.

3. A similar muzzle as in claim 1 however both sides of the muzzle will contain straps around brass buttons holding the side slits of the muzzle together. When the straps are taken off the buttons the slit widens revealing the side teeth of the animal.

4. A similar muzzle as in claim 1 however both sides of the muzzle will have a zipper which when zipped closed the animals side teeth are not visible, and when zipped open the animals side teeth are clearly visible.

5. A similar muzzle as in claim 1 however the side flaps will be held down by twist top buttons.

6. A muzzle as in claim 1 however the entire muzzle itself is twistable. When the muzzle's outer sheath is turned upon a lower sheath both sides of teeth upper and lower rows are visible, however when the sheath is rotated back to its original position the teeth are no longer visible.

7. A muzzle as in claim 5 however when the muzzle's outer sheath is turned only one side of the animal's teeth is visible the other side remains hidden.
